(19) United States
(12) Patent Application Publication
(10) Pub. No.: US 2012/0040731 A1
(43) Pub. Date: Feb. 16, 2012

(54) DRAWING METHOD, DRAWING DEVICE, AND GAME SYSTEM FOR ENTERTAINMENT GAMES BASED ON COMPUTER NETWORK PLATFORM

(76) Inventor: Andy Guo, Staten Island, NY (US)

(21) Appl. No.: 13/213,078

(22) Filed: Aug. 18, 2011

Related U.S. Application Data
(63) Continuation of application No. 13/097,114, filed on Apr. 29, 2011.
Application No. 13/097,114 is a continuation of application No. PCT/CN2009/000437, filed on Apr. 24, 2009.

(30) Foreign Application Priority Data
Oct. 31, 2008 (CN) 200810217141.3

(51) Int. Cl. G06F 17/00

(52) U.S. Cl. 463/16

(57) ABSTRACT

Direct and indirect drawing methods, drawing devices, and game systems of entertainment games based on a computer network platform. The methods of the invention include the processes of barcode vouchers printing, barcode vouchers storage, game, reading, and prize-claiming. The drawing methods of the invention possess high reliability, are low cost, and are capable of eliminating cheating. In addition, the invention solves the trust problem of the players in relation to drawing results by avoiding collusion and cheating between the staff and players, and in the meanwhile, it also improves operational efficiency and allocation of player service resources.

### CROSS-REFERENCE TO RELATED APPLICATIONS

This application is a continuation of U.S. Ser. No. 13/097,114 filed on Apr. 29, 2011, which is a National Stage Application of International Patent Application No. PCT/CN2009/000437 with an international filing date of Apr. 24, 2009, designating the United States, now pending, and further claims priority benefits to Chinese Patent Application No. 200810217141.3 filed Oct. 31, 2008. The contents of all of the aforementioned applications, including any intervening amendments thereto, are incorporated herein by reference.

### BACKGROUND OF THE INVENTION

1. Field of the Invention

The invention relates to a method and a device of drawing a result randomly from a collection of possible results for entertainment games based on a computer network platform, as well as to a game system that adopts the drawing method.

2. Description of the Related Art

The world entertainment game industry is transitioning from a traditional operational mode dominated by manpower to an operational mode dominated by computer network intelligence. Drawing methods, a critical part of the entertainment game, have failed to keep pace with the development of the industry.

At present, there are two kinds of drawing methods for entertainment games based on a computer network platform. One is a real-time drawing mode in which physical tools are coupled with an on-scene live video broadcast. Representative games that adopt such a drawing mode include lottery game with the local name for “Lottery”, the computer-based The Game of Baccarat, and the like. However, the real-time drawing mode suffers from two major disadvantages.

The first disadvantage is that such drawings are high-cost processes. To convince the audience of the credibility a lack of bias of a drawing result, a real-time retransmission of a drawing process and the result requires live broadcast on an on-scene TV at a public TV station that wins the public's trust, and, at the same time, public figures or government employees who are trusted by the public should be invited to participate in the drawing. These public human resources should be prepared and combined to invoke a feeling of justice and credibility, which thereby objectively incurs a high cost for the drawing. Secondly, due to the overly high cost of allocating resources and the complex drawing process, the drawing frequency must be reduced, and a reduction in drawing frequency will directly influence the operational efficiency and benefits.

The second disadvantage is the drawing method used in the entertainment game based on a computer network platform, which is a real-time drawing mode that uses a computer system to determine drawing result. Representative games that use such drawing methods include Keno game, Slot Machine, Scratch card Lottery, and the like. Real-time drawing modes have two inherent defects. Firstly, the credibility of a drawing result is relatively low. Because a drawing result is determined by a computer system, there is no conspicuous and convincing physical evidence to support the credibility of and lack of bias in the result. Secondly, computer systems are used to determine a drawing result, and this technically provides a way for a person to cheat and control the drawing result.

Many traditional games can be transformed into games that operate based on a computer network platform. However, feasible technical methods cannot be found for achieving a credible and just real-time drawing game, so this transformation has not yet been implemented. Therefore, a credible, low-cost, and cheating-avoiding real-time drawing method for an entertainment game based on a computer network platform is an intrinsic need of the industry. The method provided here not only solves the problem that the players trust the drawing result by avoiding collusion and cheating between the staff and the players, but the operational efficiency and allocation of player service resources is improved.

### SUMMARY OF THE INVENTION

In view of the above-described problems, it is one objective of the invention to provide a drawing method and device for an entertainment game based on a computer network platform, as well as a game system that adopts such a drawing method. To accomplish this goal, the invention adopts the following technical scheme.

To achieve the above objectives, in accordance with one embodiment of the invention, there is provided a direct drawing method for an entertainment game based on a computer network platform, comprising the steps of:
a) printing randomly selected drawing elements on the envelope of a barcode result voucher;
b) binding the drawing elements and a barcode code and storing them in a database of a game system;
c) selecting prize-claim elements by a player through the game interface in accordance with game rules;
d) scanning the barcode result voucher and reading the barcode information to activate the drawing element information stored in the database of the game system; and
e) comparing the prize-claim elements selected by the player and the drawing elements stored in the database of the game system, to produce a drawing result.

In accordance with another embodiment of the invention, there is provided a direct drawing device for an entertainment game based on a computer network platform, comprising:
a) a barcode voucher printed module used to print randomly selected drawing elements on the envelope of a barcode result voucher;
b) a barcode voucher storage module used to store the information produced by binding the drawing elements and a barcode code;
c) a game module used for the player to select prize-claim elements through the game interface based on the module in accordance with the game rules;
d) a read module used to read the barcode information by scanning the barcode result voucher, which activates the drawing element information stored in the database of a game system; and
e) a prize-claim module used to compare the prize-claim elements selected by the player and the drawing elements stored in the database of the game system, to produce a drawing result.

In accordance with still another embodiment of the invention, there is provided a direct drawing-type system for an entertainment game based on a computer network platform, comprising:
a) a barcode result voucher, in the envelope of which are printed randomly selected drawing elements;
b) a read module used to read the barcode information by scanning the barcode result voucher, to activate drawing element information stored in the database of a game system; and
c) a game host computer comprising a game interface through which the player selects prize-claim elements in accordance with game rules and a database comprising information produced by binding the drawing elements and a barcode code; after the game begins, the game host computer compares the prize-claim elements selected by the player and the drawing elements stored in the database of the game system, to produce a drawing result.

In accordance with still another embodiment of the invention, there is provided an indirect drawing method for an entertainment game based on a computer network platform, comprising the steps of:
a) printing a selection of numbers and drawing elements corresponding to randomly selected hidden codes, or the corresponding numbers of Group 1 or Group 2 plain codes, in the envelope of the barcode result vouchers;
b) binding the selection numbers and the drawing elements of the randomly selected hidden codes, or the corresponding numbers of Group 1 and Group 2 plain codes, and a barcode code, and storing the bound information in the database of a game system;
c) selecting prize-claim elements by a player through the game interface in accordance with game rules, or two competing groups of elements from Group 1 plain codes;
d) scanning the barcode result voucher and reading the barcode information to activate corresponding selection numbers and the drawing elements of hidden codes stored in the database of the game system, or corresponding numbers of Group 1 and Group 2 plain codes; and
e) selecting a group of hidden codes by the game system and corresponding them to plain codes in accordance with the selection numbers of hidden codes, comparing the prize-claim elements selected by the player and the drawing elements of hidden codes, to produce a drawing result; or corresponding Group 1 plain codes to Group 2 plain codes by the game system in accordance with the corresponding numbers of Group 1 and Group 2 plain codes, and determining the scores of two competing groups of elements chosen from Group 1 plain codes in accordance with the score randomly determined and corresponding to each element of Group 2 plain codes, to further produce a drawing result according to the scores of these two competing groups of elements.

In accordance with still another embodiment of the invention, there is provided an indirect drawing device for an entertainment game based on a computer network platform, comprising:
a) a barcode voucher printed module used to print selection numbers and drawing elements of hidden codes randomly selected, or corresponding numbers of Group 1 and Group 2 plain codes in the envelope of barcode result vouchers;
b) a barcode voucher storage module used to bind the selection numbers and the drawing elements of hidden codes randomly selected, or corresponding numbers of Group 1 and Group 2 plain codes and a barcode code, and store bound information in the database of a game system;
c) a game module used for a player choosing prize-claim elements from among the plain codes through the game interface set on the module in accordance with the game rules, or from among the two competing groups of elements from Group 1 plain codes;
d) a read module used to read the barcode information by scanning the barcode result voucher, to activate the corresponding selection numbers and the drawing elements of the hidden codes stored in the database of the game system, or the corresponding numbers of Group 1 and Group 2 plain codes; and
e) a prize-claim module used to select a group of hidden codes and correspond the hidden codes to plain codes in accordance with the selection numbers of the hidden codes, and based on this, the module further compares the prize-claim elements selected by the player and the drawing elements of the hidden codes, to produce a drawing result; or the prize-claim module corresponds Group 1 plain codes with Group 2 plain codes in accordance with the corresponding numbers of Group 1 and Group 2 plain codes, and determines the scores of the two competing groups of elements chosen from Group 1 plain codes in accordance with the score randomly determined and corresponding to each element of Group 2 plain codes, to further produce a drawing result according to the scores of these two competing groups of elements.

In accordance with still another embodiment of the invention, there is provided an indirect drawing-type system for an entertainment game based on a computer network platform, comprising:
a) a barcode result voucher, in the envelope in which are printed selection numbers and drawing elements of randomly selected hidden codes, or corresponding numbers of Group 1 and Group 2 plain codes;
b) a read module used to read barcode information by scanning the barcode result voucher, to activate corresponding selection numbers and the drawing elements of hidden codes stored in the database of a game system, or corresponding numbers of Group 1 and Group 2 plain codes; and
c) a game host computer comprising a game interface through which the player chooses prize-claim elements from plain codes or two competing groups of elements from Group 1 plain codes in accordance with the game rules; after the game begins, the game host computer chooses a group of hidden codes and corresponds them to plain codes in accordance with the selection numbers of the hidden codes, and based on this, it further compares prize-claim elements selected by the player and the drawing elements of the hidden codes, to produce a drawing result; or it corresponds Group 1 plain codes to Group 2 plain codes in accordance with the corresponding numbers of the Group 1 and Group 2 plain codes, determines the scores of the two competing groups of elements chosen from Group 1 plain codes in accordance with the score randomly determined in response to each element of Group 2 plain codes, and then produces a drawing result based on the scores of these two competing groups of elements.

Hereinafter, the invention will be further described in combination with the attached drawings and specific implementation examples.

### BRIEF DESCRIPTION OF THE DRAWINGS

FIG. 1 is a flow chart according to the direct drawing method of the entertainment game based on a computer network platform in the implementation example;

FIG. 2 is a flow chart according to the direct drawing device of the entertainment game based on a computer network platform in the implementation example;

FIGS. 3a-3d are schematic diagrams showing the combination of a game system and its game process according to the direct drawing device of the entertainment game based on a computer network platform in the implementation example;

FIG. 4 is a flow chart according to the indirect drawing method of the entertainment game based on a computer network platform in the implementation example;

FIG. 5 is a flow chart according to the indirect drawing device of the entertainment game based on a computer network platform in the implementation example;

FIGS. 6a-6c are schematic diagrams that combine a game system of plain codes and hidden codes and its game process according to the indirect drawing device of the entertainment game based on a computer network platform in the implementation example; and

FIGS. 7a-7d are schematic diagrams combining a game system of dual plain codes and its game process according to the indirect drawing device of the entertainment game based on a computer network platform in the implementation example.

### DETAILED DESCRIPTION OF THE EMBODIMENTS

### Example 1

### Direct Drawing Method, Drawing Device, and Game System

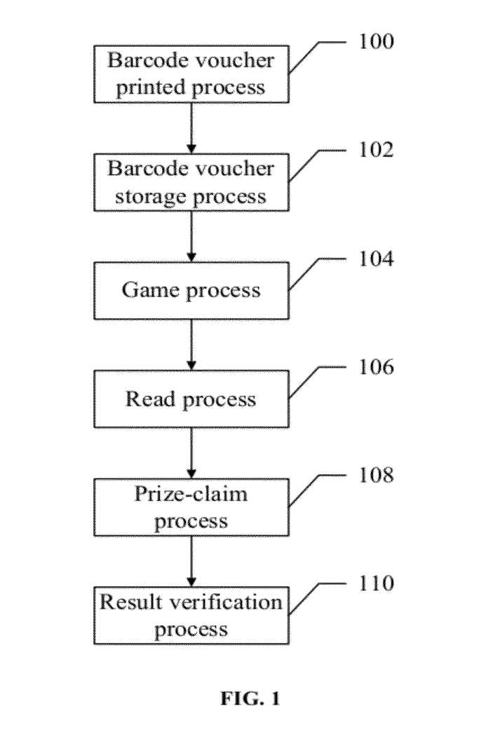

As shown in FIG. 1, the direct drawing method of the entertainment game based on a computer network platform according to the implementation example comprises the barcode vouchers printing process 100, barcode vouchers storage process 102, game process 104, read process 106, and prize-claim process 108, as well as the result verification process 110, selectively. Their respective functions are as follows: in the barcode vouchers printing process 100, randomly selected drawing elements are printed in the envelope of a barcode result voucher; in the barcode vouchers storage process 102, drawing elements are bound with a barcode code, and bound information is stored in the database of a game system; in a game process 104, the players select prize-claim elements through the game interface in accordance with the game rules; in a read process 106, barcode information is read by scanning a barcode result voucher, to activate drawing element information stored in the database of a game system; and in the prize-claim process 108, prize-claim elements selected by the players are compared with drawing elements stored in the database of the game system, to produce a drawing result. In addition, during the result verification process 110, the game system releases a barcode result voucher to complete the prize-claim program, and then the players verify the consistency between the drawing elements sealed up in a barcode result voucher and the drawing elements sent out by the game system.

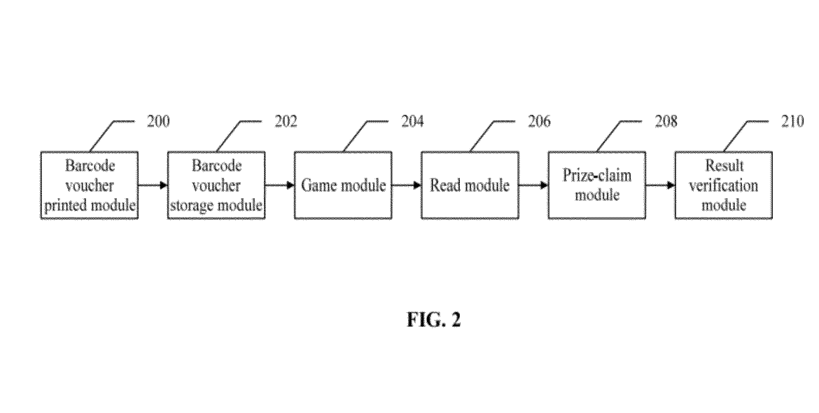

As shown in FIG. 2, the direct drawing device of the entertainment game based on a computer network platform according to the implementation example comprises a barcode vouchers printing module 200, a barcode vouchers storage module 202, a game module 204, a read module 206, and a prize-claim module 208, as well as a result verification module 210, selectively. Their respective functions are as follows: the barcode vouchers printed module 200 is used to print randomly selected drawing elements in the envelope of a barcode result voucher; the barcode vouchers storage module is used to store the information produced by binding the drawing elements and the barcode code; the game module 204 permits the player to select prize-claim elements through the game interface set based on the module; the read module 206 is used to read barcode information by scanning the barcode result vouchers, to activate drawing element information stored in the database of the game system; and prize-claim module 208 is used to compare prize-claim elements selected by the players and drawing elements stored in the database of the game system, to produce a drawing result. In addition, the result verification module 210 is used to release the barcode result voucher to complete the prize-claim program which permits the players to verify consistency between the drawing elements sealed up in a barcode result voucher and the drawing elements sent out by the game system.

Hereinafter, detailed descriptions are given of the direct drawing method and the device of the entertainment game based on a computer network platform according to the implementation example through their specific application in the game system.

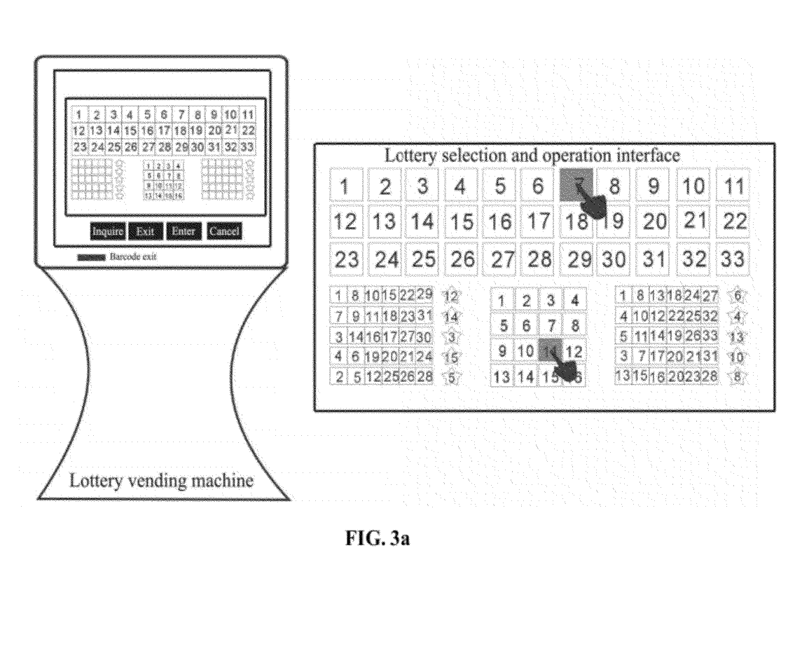

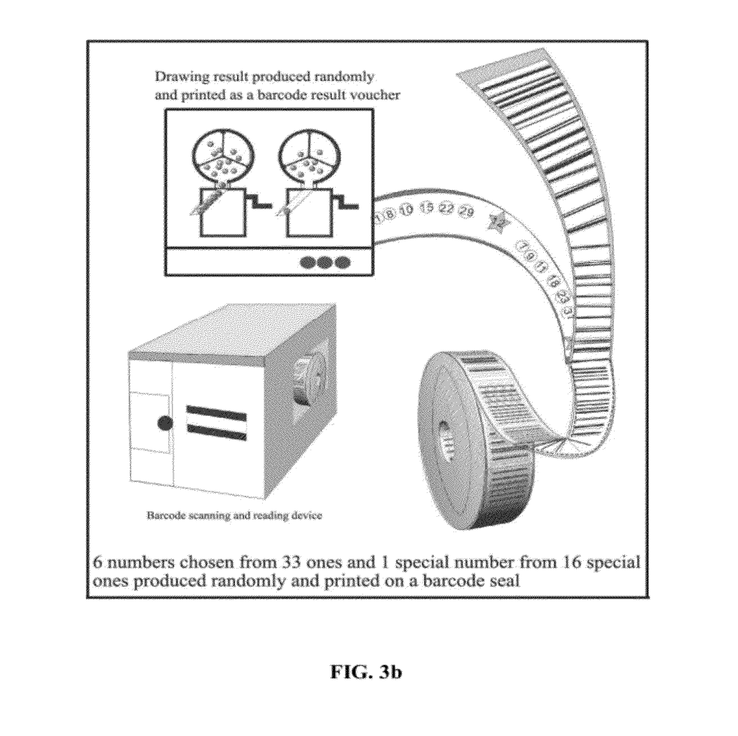

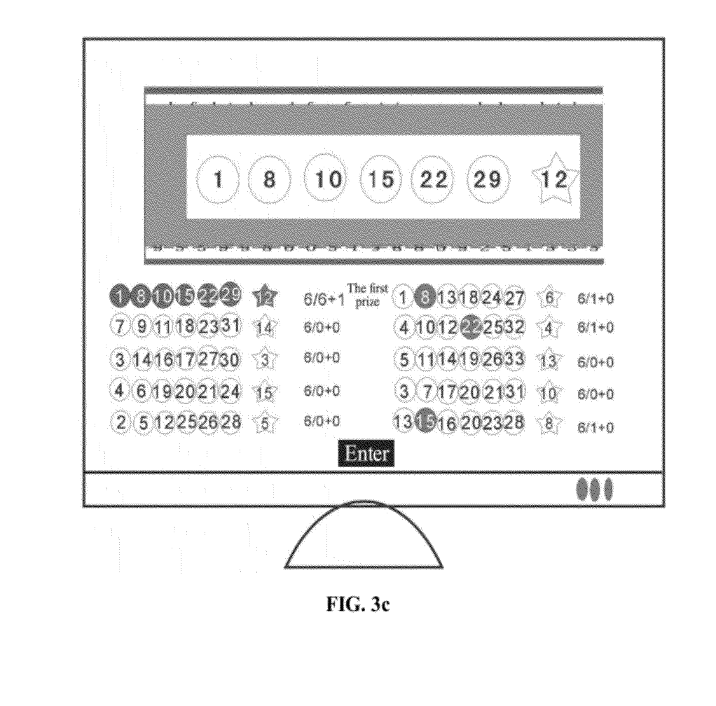

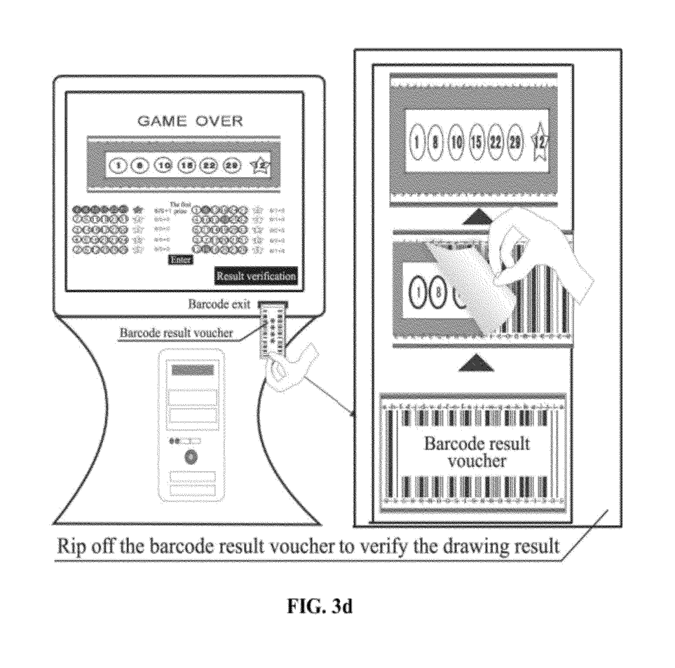

The direct real-time drawing is also called “prize-claim method for a plain code game”. The so-called prize-claim method for a plain code game is a real-time drawing method applicable to selection prize-claim-type entertainment games. The characteristics of selection prize-claim-type entertainment games are as follows: the game players guess and select prize-claim elements combined according to specific game rules, a drawing result is produced randomly by a physical tool or a computer, and judgment of the game result is conducted by comparing the prize-claim elements selected by the players and the drawing element in accordance with the game rules. Representative games of this kind comprise various bead-shaking drawing-type lottery games with the local name for “Lottery”, Keno computer drawing games, computer Bingo games, and the like. Here, the China Welfare Lottery (6 numbers chosen from 33 possible numbers, and 1 special number chosen from 16 possible special numbers) is taken as an example for providing detailed descriptions of the direct drawing method and device for an entertainment game based on a computer network platform according to the implementation example. A flow chart describing the China Welfare Lottery is as shown in FIG. 3, and the flow chart mainly involves the following processes:

(1) The game players select prize-claim number combinations through the game interfaces of lottery vending machines in accordance with the game rules of the Welfare Lottery, and the prize-claim numbers selected are displayed on the touch screen of the game computer (for example, the game host computer) in the form of the number of prize-claim numbers selected and an arrangement thereof. The game players must select prize-claim number combinations as guesses for winning prizes for a prize-claim, each group (also referred to as each bet) of prize-claim combinations (also referred to as prize-claim elements) are formed from 6 numbers chosen from 33 possible numbers to be selected and 1 special number chosen from 16 special possible numbers, as shown in FIG. 3a;

(2) Drawing elements are printed in a barcode result voucher. The barcode on a barcode result voucher contains such information as can activate the drawing elements stored in the database of a lottery vending machine, which are consistent with the drawing elements sealed up in the barcode result voucher. Randomly selected drawing elements are printed in the barcode result voucher and sealed up in the envelope of the barcode result voucher, as shown in FIG. 3b. With such a reliable and unchangeable physical preservation mode, the credibility a lack of bias in a drawing result can be guaranteed. Moreover, one or more barcode result vouchers can be provided in each game. The preferred mode is to provide a plurality of barcode result vouchers in a game, and the players can randomly select one of them as the result voucher of the game;

(3) After scanning, reading, and decoding drawing information in the envelope of a barcode result voucher, a scanning and reading device (i.e., the scanning module) transmits the data information contained in the barcode code to the database of the game computer. The barcode code serves to activate the drawing result stored in the database which is consistent with the barcode result voucher, and to extract it for use in a prize-claim. The drawing result extracted from the database of lottery vending machines is fully consistent with the physical drawing result sealed up in the barcode result voucher.

(4) The computer system of the lottery vending machine compares the drawing result obtained from the database and the prize-claim numbers selected by the game players, to produce the game result, as shown in FIG. 3c;

(5) The real-time drawing system in a lottery vending machine releases the barcode result voucher to complete the computer prize-claim program, and then the game players can check the drawing elements by ripping off the double-layer sticker or envelope, to verify whether the prize-claim elements used by the computer system are correct. The whole prize-claim and drawing process is concluded here, as shown in FIG. 3d.

The barcode result voucher is composed of a barcode sticker and a data information envelope, or a scratch card lottery lead sealing ticket. The barcode serves to activate the drawing information stored in the database of the game system, consistent with the result voucher associated with its carried code. The working principle of the barcode is as follows: each piece of drawing information is associated with one group of computer program codes as its representative, and each group of computer program codes correspond to one group of barcode code. Before a barcode result voucher is printed, drawing information and representative codes are bound with the computer recognition program, and the representative codes are randomly selected and bound automatically and randomly with the drawing information randomly selected in the computer system (the binding program can be either permanent or different for different batches of barcode result vouchers, as the case may be). After representative codes and drawing information are bound together, barcode result voucher can be printed, namely, representative codes and barcode codes are relatively bound by means of a computer recognition program, and at the same time, a new computer recognition program is generated and implanted into the database of the game system as drawing information. The drawing information recognition program of the barcode is an encrypted computer program and data package, which serves to guarantee the safety of the resulting voucher information. The barcode sticker on the result voucher or the barcode on the scratch card lottery lead sealing ticket is designed in a seal-type assurance mode during printing, to eliminate the possibility of human-derived cheating, namely, any endeavor to obtain drawing information by uncovering the barcode envelope will be in vain. After scanning the barcode on the result voucher, the scanning and reading system obtains the code and instantly transmits it to the computer recognition program in the game system. The computer recognition program uses the code to seek out the representative code of the drawing information bound with the code, and then the representative code actives the drawing information, which is then transmitted into the prize-claim computer program to complete the prize-claim process; in the data information envelope in the result voucher is printed drawing information (including drawing results or drawing prompts), which exists in physical form for use in verification by the game players. The result voucher can be made from any physical material and developed into a barcode result voucher in any form, depending on the cost or demands. The scanning and reading device serves to scan and read the code in the barcode and transmit relevant data information into the database of the game system, as well as to assist the computer prize-claim program in the game system to ensure the credibility of the real-time drawing.

### Example 2

### Indirect Drawing Method, Drawing Device, and Game System

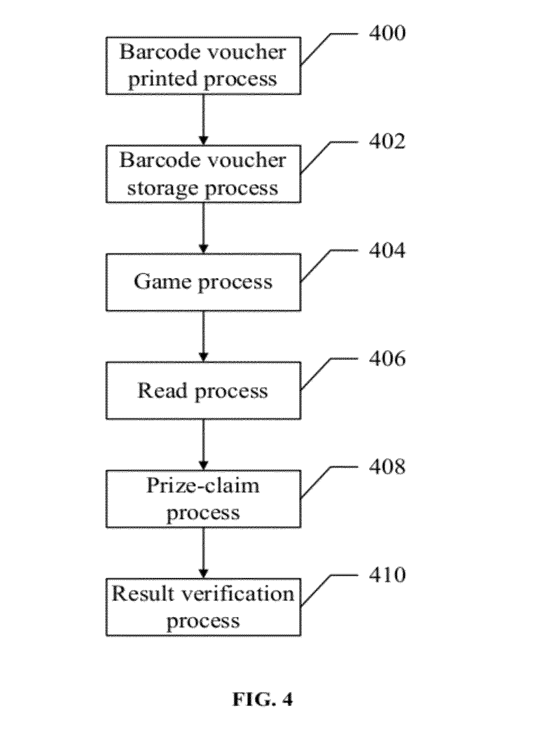

As shown in FIG. 4, the indirect drawing method of the entertainment game based on a computer network platform according to the implementation example comprises a barcode vouchers printing process 400, a barcode vouchers storage process 402, a read process 406, and a prize-claim process 408, as well as a result verification process 410. Their respective functions are as follows: in the barcode vouchers printing process 400, selection numbers and drawing elements corresponding to randomly selected hidden codes, or the corresponding numbers of Group 1 and Group 2 plain numbers, are printed in the envelope of a barcode result voucher; in the barcode vouchers storage process 402, the information produced by binding the selection numbers and the drawing elements of randomly selected hidden codes, or corresponding numbers of Group 1 and Group 2 plain codes and the barcode code, is stored in the database of the game system; in the game process 404, the players choose prize-claim elements from plain codes through the game interface in accordance with the game rules, or two competing groups of elements from Group 1 plain codes; in the read process 406, barcode information is read by scanning the barcode result voucher, to activate the corresponding selection numbers and drawing elements of hidden codes stored in the database of the game system, or the corresponding numbers of Group 1 and Group 2 plain codes; and in the prize-claim process 408, the game system selects a group of hidden codes and corresponds them to plain codes in accordance with the selection numbers of the hidden codes, and based on this, it further compares prize-claim elements selected by players and drawing elements of hidden codes, to produce drawing result; or the game system corresponds Group 1 plain codes to Group 2 plain codes in accordance with the corresponding numbers of Group 1 and Group 2 plain codes, and determines the scores of two competing groups of elements chosen from Group 1 plain codes in accordance with a score that is randomly determined and corresponds to each element of Group 2 plain codes, to further produce a drawing result according to the scores of the two competing groups of elements. In the result verification process 410, the game system releases the barcode result voucher to complete a prize-claim program, and then the players verify the consistency between the drawing information sealed in the barcode result voucher and the drawing information sent out by the game system.

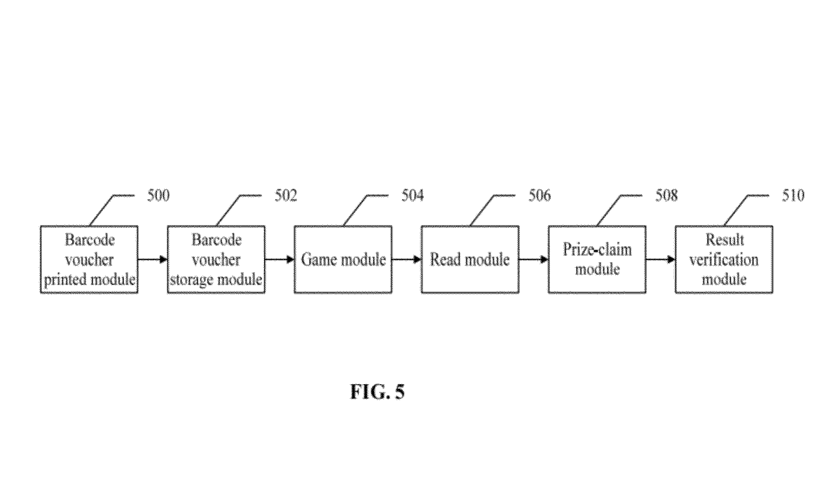

As shown in FIG. 5, the indirect drawing device of the entertainment game based on a computer network platform according to the implementation example comprises a barcode vouchers printing module 500, a barcode vouchers storage module 502, a game module 504, a read module 506 and a prize-claim module 508, as well as a result verification module 510. Their respective functions are as follows: the barcode vouchers printing module 500 is used to print selection numbers and drawing elements of randomly selected hidden codes, or corresponding numbers of Group 1 and Group 2 plain codes, in the envelope of a barcode result voucher; the barcode voucher storage module 502 is used to bind selection numbers and drawing elements of randomly selected hidden codes, or corresponding numbers of Group 1 and Group 2 plain codes and barcode code, and store the bound information in the database of the game system; the game module 504 permits the players to chose, through the game interface set thereon and in accordance with game rules, prize-claim elements from among plain codes, or two competing groups of elements from Group 1 plain codes; the read module 506 is used to read the barcode information by scanning the barcode result voucher, to activate the corresponding selection numbers and drawing elements of the hidden codes stored in the database of the game system, or corresponding numbers of Group 1 and Group 2 plain codes; and the prize-claim module 508 is used to select a group of hidden codes and correspond them to plain codes in accordance with the selection numbers of the hidden codes, and based on this, it further compares the prize-claim elements selected by the players and the drawing elements of the hidden codes, to produce a drawing result; or the module corresponds Group 1 plain codes to Group 2 plain codes in accordance with the corresponding numbers of Group 1 and Group 2 plain codes, and determines the scores of the two competing groups of elements chosen from Group 1 plain codes in accordance with a score that is randomly determined and corresponds to each element of the Group 2 plain codes, to further produce a drawing result according to the scores of these two competing groups of elements. In addition, the result verification module 510 is used to release the barcode result voucher to complete the prize-claim program, and then the players verify the consistency between the drawing information sealed up in a barcode result voucher and the drawing information sent out by the game system.

Hereinafter, detailed descriptions are given to the indirect drawing method and device of the entertainment game based on a computer network platform according to the implementation example through their specific application in the game system.

The indirect real-time drawing method can be divided into two types: a “static drawing method of plain and hidden codes” and a “dynamic drawing method of dual plain codes”. The so-called “indirect real-time drawing method” is distinct from the direct real-time drawing method and is complementary of the latter. Its main function is to provide a sound safety net for possible safety loopholes in the direct real-time drawing process and result. The indirect real-time drawing method possesses not only all advantages of the direct real-time drawing method in its realization scheme, but it also possesses the unique feature that prize-claim elements to be selected are separated from the drawing elements with plain and hidden codes or dual plain codes, thus artificially building a cheating-avoiding firewall in the drawing flow. The indirect real-time drawing technology uses a computer system to determine the prize-claim function of the static plain and hidden codes or the dynamic dual plain codes through the game interface, to guarantee the safety of the drawing process and result. Applied in the entertainment game based on a computer network platform, the indirect real-time drawing method can prevent the large majority of human-derived cheating in the real-time drawing flow, to ensure credibility a lack of bias in a drawing process and result. The indirect real-time drawing technology is applicable to most selection prize-claim-type entertainment games, as well as the vast majority of selection competing-type entertainment games. In the competing-type entertainment games, there are generally two or more sides competing to win the game, and judgment of the game result depends on the game rules. In traditional competing-type games, the game players bets on one side selected from two or more competing sides in accordance with specific game rules; whereas in the competing-type entertainment games based on a computer network platform, competing occurs between machine and human, and the game players can select and bet on the hand of one side to compete against that of the other in a virtual scene. Drawing does not adopt a direct prize-claim mode, but relies on drawing instructions from the result voucher and game computer system (including two indirect real-time drawing computer systems, i.e., static plain and hidden codes and dynamic dual plain codes) to determine the combination results of the hands of both competing sides in the game. The competing result of the hands representing the competing sides is then judged in accordance with the game rules, to produce the game result. Printed in the barcode result voucher of the indirect real-time drawing technology are not drawing elements but instructions for corresponding combinations of plain and hidden codes or dual plain codes in the game. The drawing result of the game is determined by both the combination instructions and the corresponding method of plain and hidden codes or dual plain codes in the game, and the game result is then judged in accordance with the game rules.

Hereinafter, the Lottery Game (6 numbers chosen from 36 possible numbers) is taken as an example to explain the static prize-claim method of the plain and hidden codes, and the Three Card Poker Game is taken to illustrate the dynamic prize-claim method of the dual plain codes.

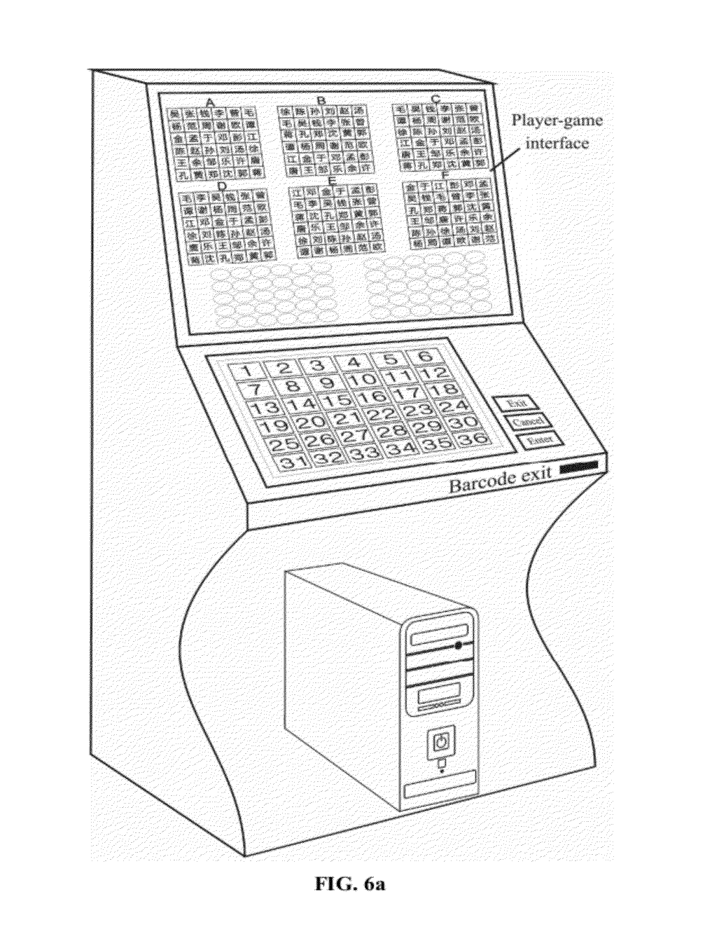

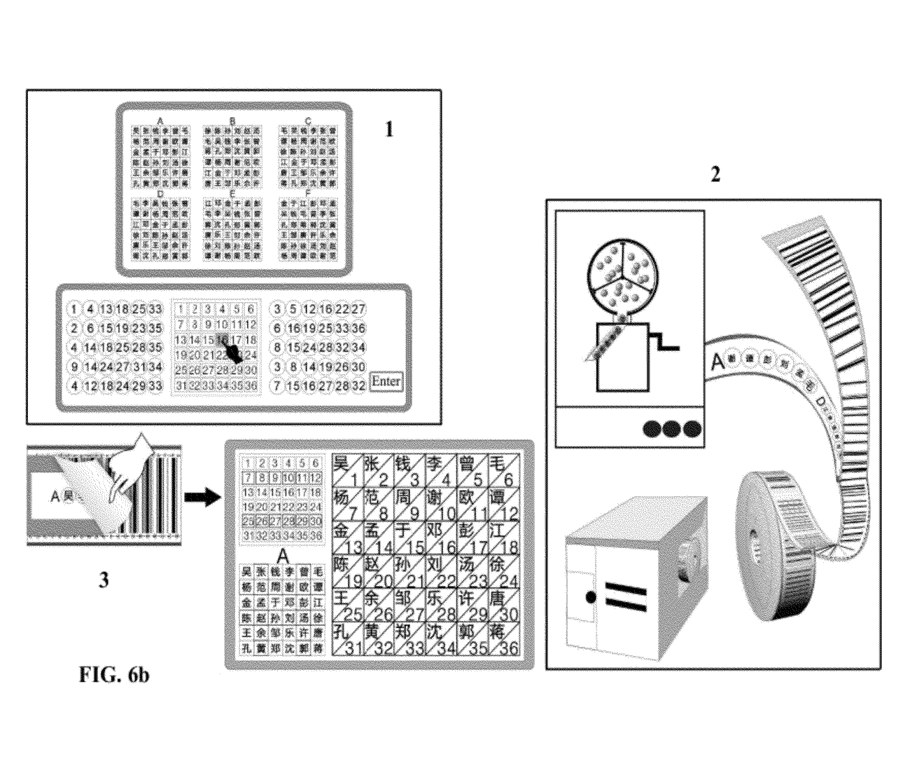

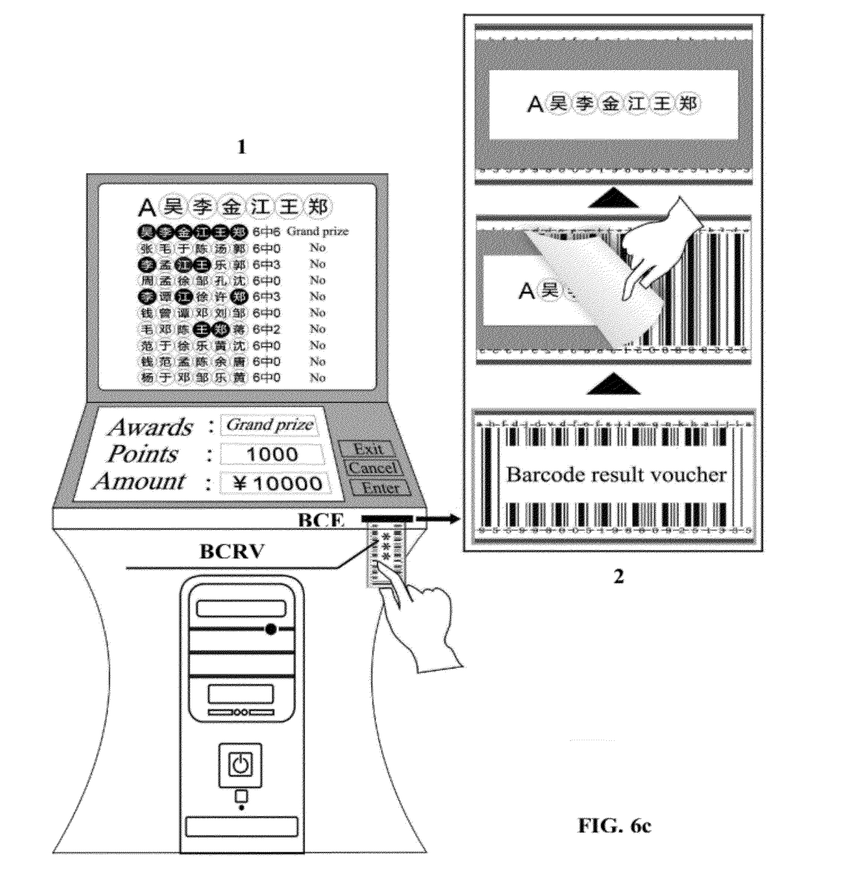

1. Lottery Game (6 numbers chosen from 36 possible numbers) is typical of selection prize-claim type entertainment games, and also is the best example of the application of the indirect real-time drawing mode “static prize-claim method of plain and hidden codes”. The traditional drawing mode of manual bead-shaking coupled with TV field pickup is transformed into a real-time drawing mode with the same operational effect but an extremely large difference in costs and benefits, thus the simple and safe lottery vending machine replaces the complex and inconvenient manual operational mode, which provides myriad cheating opportunities, and the simple and safe lottery vending machine best exemplifies the commercial value of the invention. As shown in FIG. 6, the following processes comprise the method:

A. The game interface of a lottery vending machine displays a keystroke chart of plain code combinations to be selected (36 Arabic numerals (or other symbols)) and 6 (surely not limited to 6, and 1, 2, 3, 4, 5, 7 or more are permitted) charts of the hidden code combinations to be selected (36 family names of single characters selected from among the Chinese Last Names (or other symbols)). The chart of plain code combinations to be selected is represented by 36 lottery numbers to be selected (1-36), and these lottery numbers are randomly selected by computer and arranged in a square table with 36 panes. The table is placed in the middle of the lower part of the computer (game host computer) game interface. The aforementioned charts of hidden code combinations are represented by single Chinese characters (36 family names of single character among Chinese Last Names), the display patterns of which are identical with that of the chart of plain code combinations, and these 6 charts to be selected are denoted by A-F, and are placed in the upper part of the game interface. Hidden code combinations are also randomly selected by computer and arranged in a square table with 36 panes. Each game provides 6 hidden code combinations with different arranging sequences from which the game players can select one as a prize-claim hidden code. The arrangement of sequences of plain and hidden codes in the charts is randomly selected and not guessable in each game. The game players only need to select 6 prize-claim hidden codes (they guess them to win prize) in the chart of plain code combinations using keystrokes, then combine them into one group in accordance with the game rules, each group (also referred to as one bet) of prize-claim combination (also referred to as a prize-claim element) is formed of 6 numbers (repeatable or unrepeatable, partially repeated or totally repeated) chosen from 36 possible numbers to be selected. In theory, all bets to be selected can be all combinations formed from 6 numbers chosen from 36 possible numbers, as shown in FIG. 6a;

B. The first step of entering the game is to select a prize-claim combination (prize-claim element combination) in the chart of prize-claim plain code combinations using keystrokes, and press a confirmation button to enter the prize-claim program. The prize-claim programs are divided into 3 steps: first, the computer system starts up the indirect real-time drawing system in the lottery vending machine, and the scanning and reading device (i.e., the read module) of a barcode result voucher in the indirect real-time drawing system comes into operation. The working principle is as follows: the mechanical device in the game computer acquires a result voucher from the barcode result voucher ticket stored in the real-time drawing system in terms of the sequence, and gains two kinds of information sealed up in the result voucher by scanning and reading the barcode. One kind of information is selection instructions of the chart of hidden codes (namely, prize-claim instructions, an English letter in the game which is one of the English letters respectively denoting 6 charts of hidden codes to be selected). The function of the information is to select one chart of hidden codes as the corresponding instructions for the plain and hidden codes in the game, to reach the indirect drawing effects of the game. The other is a drawing hidden code combination (i.e., a drawing element), which serves as the physical result of a drawing, and wins the trust of the game players. Second, after receiving the selection instructions of the chart of hidden codes read by the scanning and reading of barcodes device, the computer system in the lottery vending machine automatically selects the chart of hidden code combinations represented by the English letter as the corresponding drawing chart of the plain code chart in the game in accordance with the selection instructions, and overlaps and corresponds the plain code chart and the hidden code chart on the virtual interface of a computer game platform, to obtain the corresponding result between plain codes and hidden codes. Third, based on the corresponding result between plain codes and hidden codes obtained by the computer system, the plain code prize-claim combination selected by the game players is transformed into the hidden code prize-claim combination, to acquire the hidden prize-claim combination which directly corresponds to the drawing result, as shown in FIG. 6b. Moreover, one or more barcode result vouchers can be provided in each game. The preferred mode is to provide a plurality of barcode result vouchers in a game, and the players can randomly select one of them as the result voucher of the game;

C. After receiving the barcode code information transmitted by the scanning and reading of barcodes device, the computer game system in the lottery vending machine instantly activates the drawing element information stored in the database, which is identical with the hidden code drawing combination in the result voucher carried by the barcode, and then the drawing element information is sent to the computer game system, to start up the game prize-claim program; the game prize-claim program automatically compares the prize-claim combination transformed into the hidden code prize-claim elements with the drawing elements, judges if each group of prize-claim elements (also referred to as each betting combination) wins a prize, and displays the drawing and prize-winning result through the game interface for verification by the game players;

D. After the game computer completes the automatic prize-claim program and produces the final game result, the game players can finish the game prize-claim program by pressing the confirmation button through the game interface, and the computer game interface displays the real-time drawing result of the lottery game and all elements and scenes revealing the final game result. Then the real-time drawing system of the computer game releases the envelope of the barcode result voucher (or scratch card lottery ticket) containing physical drawing information, to complete the computer prize-claim program, and the game players can verify if the computer prize-claim result is correct by ripping off the envelope of the barcode result voucher and checking the drawing information therein. Up to this point, the whole game flow of the self-service real-time drawing lottery game of plain and hidden codes (6 numbers chosen from 36 possible numbers) (including self-service prize-claim plain code combinations, automatic transformational flow between plain codes and hidden codes, prize-claim and drawing flow, and the like) is concluded, as shown in FIG. 6c.

2. “Three Card Poker” game is typical of selection competing-type entertainment games, and also provides a good example of the application of the indirect real-time drawing mode “dynamic prize-claim method of dual plain codes”. The traditional operational mode of on-scene manual dealing is transformed into the operational mode of a man-machine game computer with the same operational effects but extremely large differences in costs and benefits. Thus, the simple and safe self-service game computer replaces the complex and inconvenient manual operational mode with myriad cheating opportunities. Hereinafter the “Three Card Poker” game and its supporting game computer are taken as an example to explain the dynamic prize-claim method of dual plain codes. As shown in FIG. 6, the following processes comprise the method in the example:

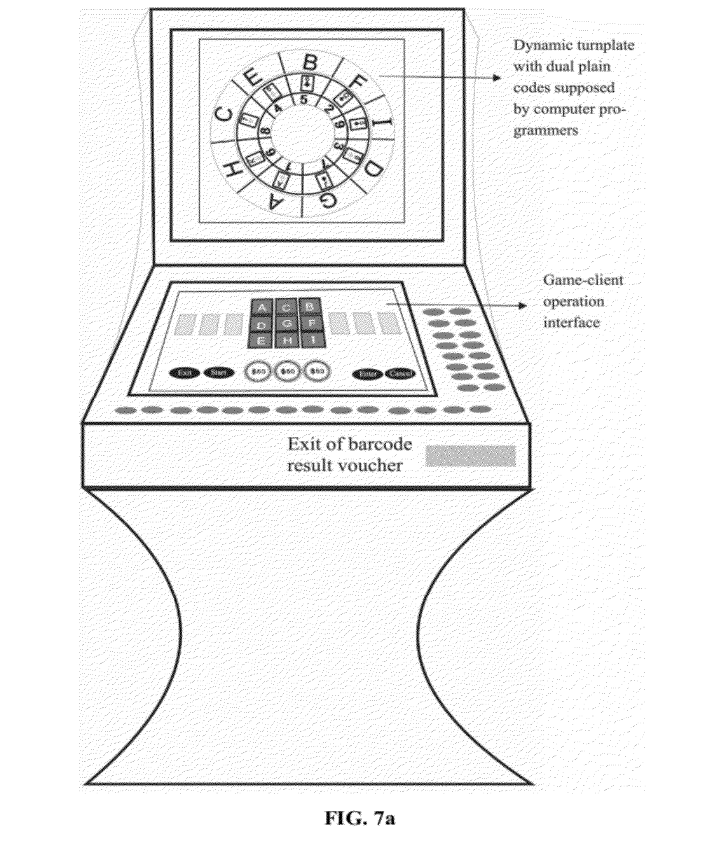

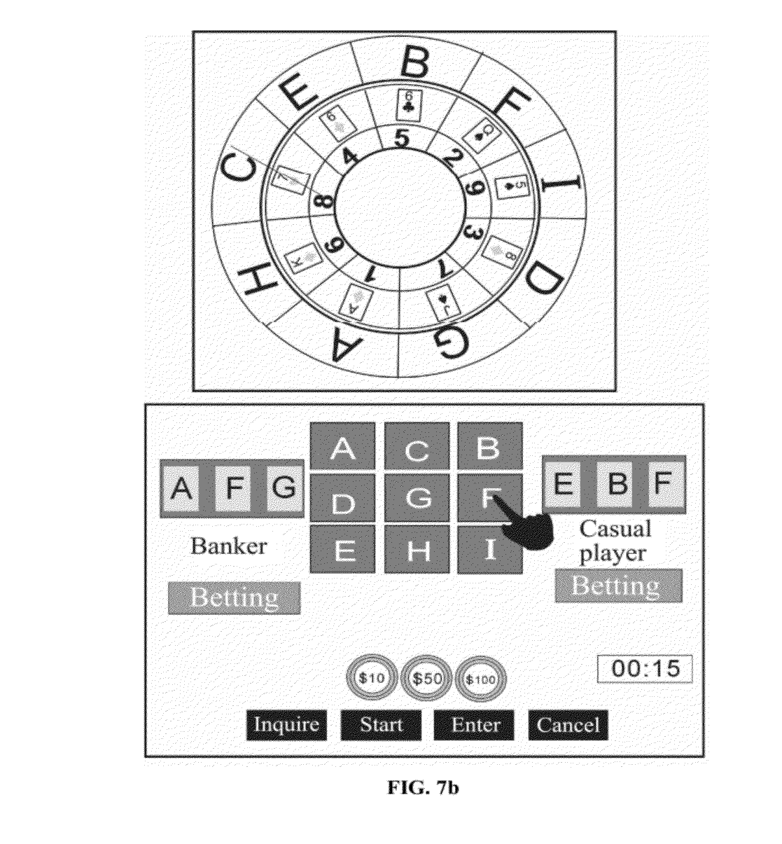

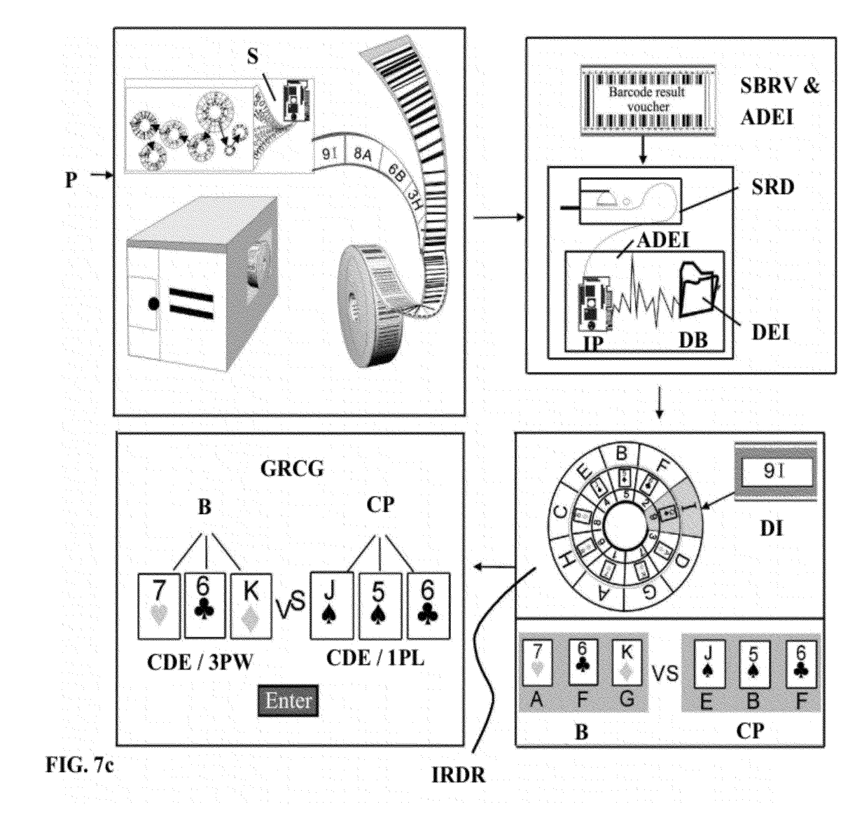

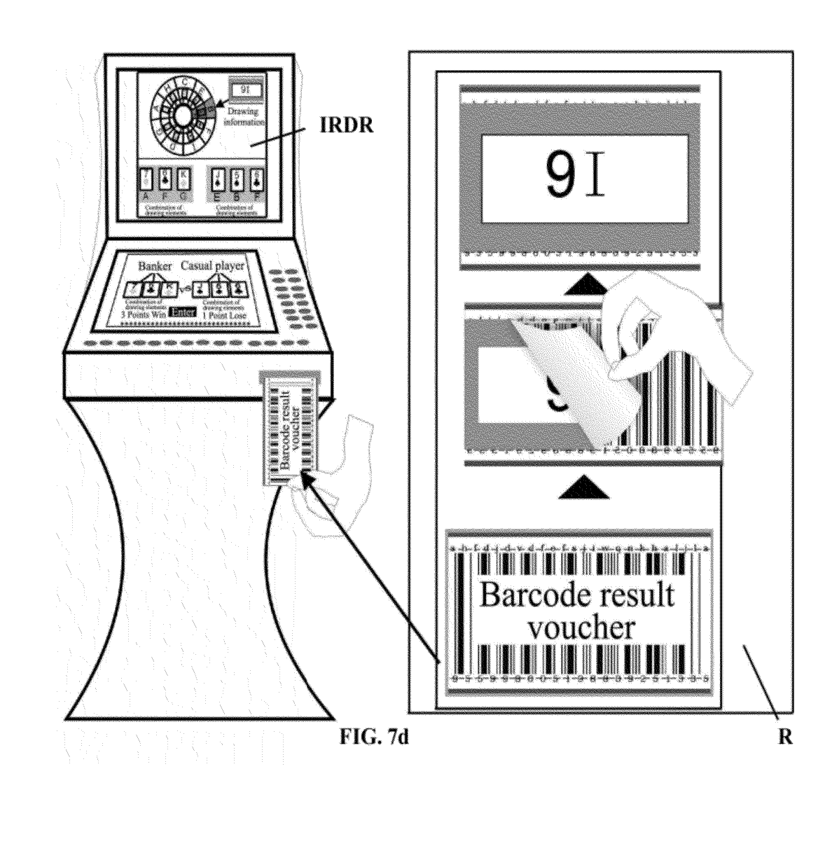

A. The “Three Card Poker” game and the game interface of its supporting game computer are provided with a virtual man-machine game platform and scene through the game computer system. The game platform displays a chart of plain code combinations to be selected (9 minor square lattices form a big square lattice, each minor lattice is provided with an English letter as a plain code to be selected, and there are 9 such letters as A, B, C, D, E, F, G, H, and J). These letters in the chart of plain code combinations to be selected are randomly selected in each game, and their arranging sequences are unpredictable. In addition, there is a simulative turnplate entitled “dynamic turnplate with dual plain codes” which constitutes the game scene through the game interface. The dynamic turnplate with dual plain codes is made up of two concentric simulative turnplates of different size, which serve to simulate shuffling and dealing programs of the “Three Card Poker” game, and which also has the technical function of realizing the real-time drawing of the game. In the dynamic turnplate of the dual plain codes, the larger-size turnplate in the outer ring is called the turnplate of the plain codes to be selected (i.e., the first plain code turnplate), and the other smaller size turnplate in the inner ring is called the turnplate of the corresponding plain codes (i.e., the second plain code turnplate). Both turnplates are divided into 9 corresponding minor lattices of the same size, and 9 minor lattices in the turnplate of the plain codes to be selected are provided with English letters (A, B, C, D, E, F, G, H, J (other symbols are also permitted)) as the signs which are the same as and correspond to 9 English letters in the chart of plain code combinations to be selected and displayed on the game platform. These two plain code turnplates have inner and outer rims, both of which are divided into 9 minor lattices with the same lattice line. 9 minor lattices in the outer ring are supplied with 9 Poker cards randomly selected from one pack of Poker cards, and these cards are placed face upwards and totally open (referred to as plain cards). The 9 minor lattices in the inner ring are provided with Arabic numerals 1-9 (can be substituted by other symbols) as corresponding plain codes, which provides codes corresponding to the English letters of the plain codes to be selected. The Arabic numerals as the corresponding plain codes are randomly selected in each game, are arranged in the lattices of the inner ring of the turnplate of the corresponding plain codes, and their arranging positions and sequences are unpredictable. Each Arabic numeral in the inner ring is bound with the Poker card in the corresponding lattice of the outer ring as a pair, to form the corresponding relation between plain codes and prize-claim elements. After the game players start up the game program, the “dynamic turnplate of dual plain codes” begins a simulative rotation. The turnplate of the plain codes to be selected and the turnplate of the corresponding plain codes rotate in the opposite direction, with one rotating in the clockwise direction and the other in the anti-clockwise direction. The rotating directions can alternate in each game, with different rotating speeds, and arrive at an unpredictable effect through random switching by the computer system, as shown in FIG. 7a;

B. The first step of entering the game program: the game players first select one hand from two competing hands as their betting object, and following that, they can select competing combinations for two competing hands in the chart of plain code combinations to be selected in accordance with game rules. Each hand in the “Three Card Poker” game constitutes 3 Poker cards, and the game players select 3 cards for two hands, respectively, in alternate ways by pressing buttons in the chart of the plain code combinations to be selected (each button is only pressed once, to ensure that the selected cards are not repeated and conform to the rules of the “Three Card Poker” game); after combinations for two competing hands are selected, the confirmation button can be pressed to enter the prize-claim program, as shown in FIG. 7b;

C. The prize-claim program (the selection competing type game is also called the competing game) comprises 3 steps. First, the computer system starts the indirect real-time drawing system in the self-service game computer, and the scanning and reading device (i.e., read module) of the barcode result voucher in the indirect real-time drawing system comes into operation. After receiving the barcode code information transmitted by the scanning and reading device of the barcode result voucher, the computer game system instantly activates the prize-claim information stored in the database, which is identical to the prize-claim instruction in the result voucher carried by the barcode, and the drawing information is sent to the computer game system of the self-service game computer, to start the game prize-claim program. The working principle is as follows: the mechanical device in the game computer acquires a result voucher from the barcode result voucher tickets stored in the real-time drawing system in terms of sequence, and gains the prize-claim instruction information sealed up in the result voucher by scanning and reading the barcode. The prize-claim instruction information is the selection instructions (i.e., prize-claim instructions, which is a combination of one English letter and one Arabic numeral in the “Three Card Poker” game) of the points corresponding to the plain codes and the plain codes corresponding to the dynamic turnplate of the dual plain codes. Second, after the computer program receives the prize-claim instruction transmitted by the indirect real-time drawing system, the turnplate of plain codes to be selected and the turnplate of corresponding plain codes in the dynamic turnplate of the dual plain codes stops rotating in accordance with the instruction, and the corresponding positions of these two turnplates should be such that the English letter (in the prize-claim instruction) representing the turnplate of the plain codes to be selected and the Arabic numeral (in the prize-claim instruction) representing the turnplate of the corresponding plain codes are exactly in the same minor lattice and correspond to each other, and other English letters (plain codes to be selected) in the other 8 minor lattices also correspond to the other corresponding Arabic numerals (corresponding plain codes), thus forming a static state ready for the prize-claim program. Third, alternate transformations between plain codes are conducted, and at the same time, the prize-claim elements are determined. The English letter of the plain code to be selected first corresponds to the Poker card (prize-claim element) bound with the corresponding plain code, then the computer game system transforms the plain code to be selected, which is represented by the English letter in the corresponding point into the corresponding Poker card, to further arrive at the combination result of two competing hands selected by the game players with plain codes to be selected previously, and up to this point, the indirect drawing effect of the game can be realized. Following this, the game enters the prize-claim program (also referred to as the competing program). The computer game system in the game computer judges the competing result of two hands in accordance with the game rules, and conducts and completes a payout procedure and the like after obtaining the game result, as shown in FIG. 7c.

D. After the game computer completes the automatic prize-claim program and obtains the final game result, the game players can press confirmation buttons to finish the game prize-claim program. The computer game interface still displays the real-time drawing result of the lottery game and all elements and scenes revealing the final game result. In the end, the real-time drawing system of the computer game releases the envelope of the barcode result voucher (or scratch card lottery ticket) containing physical drawing information and completing the computer prize-claim program, and the game players can verify whether the computer prize-claim program and result are correct by ripping off the envelope of the barcode result voucher and checking the drawing information therein. Up to this point, the whole game flow of the self-service real-time drawing game of the dynamic dual plain codes (including self-service prize-claim plain code combinations (combinations of two competing hands), corresponding and automatic transformational flow between dual plain codes, prize-claim (competing), and drawing flow, and the like) is concluded, as shown in FIG. 7c.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A direct drawing method for an entertainment game based on a computer network platform, comprising:
a) printing randomly selected drawing elements on the envelope of a barcode result voucher;
b) binding the drawing elements and a barcode code and storing them in a database of a game system;
c) selecting prize-claim elements by a player through the game interface in accordance with game rules;
d) scanning the barcode result voucher and reading the barcode information to activate the drawing element information stored in the database of the game system; and
e) comparing the prize-claim elements selected by the player and the drawing elements stored in the database of the game system, to produce a drawing result.

2. The direct drawing method of claim 1 further comprising releasing the barcode result voucher completing prize-claim program by the game system such that the player verifies consistency between the drawing elements sealed up in the barcode result voucher and the drawing elements sent out by the game system.

3. A direct drawing device for an entertainment game based on a computer network platform, comprising:
a) a barcode voucher printed module used to print randomly selected drawing elements on the envelope of a barcode result voucher;
b) a barcode voucher storage module used to store the information produced by binding the drawing elements and a barcode code;
c) a game module used for the player to select prize-claim elements through the game interface based on the module in accordance with the game rules;
d) a read module used to read the barcode information by scanning the barcode result voucher, which activates the drawing element information stored in the database of a game system; and
e) a prize-claim module used to compare the prize-claim elements selected by the player and the drawing elements stored in the database of the game system, to produce a drawing result.

4. The direct drawing device of claim 3, further comprising a result verification module used to release the barcode result voucher completing prize-claim program, under control of the game system, and then the player verifies consistency between the drawing elements sealed up in the barcode result voucher and the drawing elements sent out by the game system.

5. A direct drawing-type system for an entertainment game based on a computer network platform, comprising:
a) a barcode result voucher, in the envelope of which are printed randomly selected drawing elements;
b) a read module used to read the barcode information by scanning the barcode result voucher, to activate drawing element information stored in the database of a game system; and
c) a game host computer comprising a game interface through which the player select prize-claim elements in accordance with game rules and a database comprising information produced by binding the drawing elements and a barcode code; after the game begins, the game host computer compares the prize-claim elements selected by the player and the drawing elements stored in the database of the game system, to produce a drawing result.

6. The direct drawing-type system of claim 5, further comprising a result verification module used to release the barcode result voucher completing prize-claim program, under control of the game system, and then the player verifies consistency between the drawing elements sealed up in the barcode result voucher and the drawing elements sent out by the game system.

7. The direct drawing-type system of claim 5, comprising a plurality of barcode result vouchers; the player select one of them in a game as the result voucher of the game.

8. An indirect drawing method of an entertainment game based on a computer network platform, comprising:
a) printing a selection of numbers and drawing elements corresponding to randomly selected hidden codes, or the corresponding numbers of Group 1 or Group 2 plain codes, in the envelope of the barcode result vouchers;
b) binding the selection numbers and the drawing elements of the randomly selected hidden codes, or the corresponding numbers of Group 1 and Group 2 plain codes and a barcode code, and storing the bound information in the database of a game system;
c) selecting prize-claim elements by a player through the game interface in accordance with game rules, or two competing groups of elements from Group 1 plain codes;
d) scanning the barcode result voucher and reading the barcode information to activate corresponding selection numbers and the drawing elements of hidden codes stored in the database of the game system, or corresponding numbers of Group 1 and Group 2 plain codes; and
e) selecting a group of hidden codes by the game system and corresponding them to plain codes in accordance with the selection numbers of hidden codes, comparing the prize-claim elements selected by the player and the drawing elements of hidden codes, to produce a drawing result; or corresponding Group 1 plain codes to Group 2 plain codes by the game system in accordance with the corresponding numbers of Group 1 and Group 2 plain codes, and determining the scores of two competing groups of elements chosen from Group 1 plain codes in accordance with the score randomly determined and corresponding to each element of Group 2 plain codes, to further produce a drawing result according to the scores of these two competing groups of elements.

9. The indirect drawing method of claim 8, further comprising releasing the barcode result voucher completing the prize-claim program by the game system, and verifying consistency by the player between the drawing information sealed up in the barcode result voucher and the drawing information sent out by the game system.

10. The indirect drawing method of claim 8, wherein arrangement of the plain codes and hidden codes are randomly determined, and the quantity of hidden codes of different arrangement in each game is pre-established; arrangement of the Group 1 and Group 2 plain codes is also randomly determined, and the score randomly determined and corresponding to each element of the Group 2 plain codes is different in different games.

11. The indirect drawing method of claim 9, wherein arrangement of the plain codes and hidden codes are randomly determined, and the quantity of hidden codes of different arrangement in each game is pre-established; arrangement of the Group 1 and Group 2 plain codes is also randomly determined, and the score randomly determined and corresponding to each element of the Group 2 plain codes is different in different games.

12. The indirect drawing method of claim 8, wherein the plain codes are randomly arranged numbers with pre-established quantity, and the hidden codes are randomly arranged family names of single Chinese character with the same quantity; the Group 1 plain codes are letters, and the Group 2 plain codes are numbers; poker cards with the same quantity as plain codes are randomly selected to correspond to each element of Group 2 plain codes, to determine the scores of two competing groups of elements.

13. The indirect drawing method of claim 9, wherein the plain codes are randomly arranged numbers with pre-established quantity, and the hidden codes are randomly arranged family names of single Chinese character with the same quantity; the Group 1 plain codes are letters, and the Group 2 plain codes are numbers; poker cards with the same quantity as plain codes are randomly selected to correspond to each element of Group 2 plain codes, to determine the scores of two competing groups of elements.

14. An indirect drawing device of an entertainment game based on computer network platform, comprising:
a) a barcode voucher printed module used to print selection numbers and drawing elements of hidden codes randomly selected, or corresponding numbers of Group 1 and Group 2 plain codes in the envelope of barcode result vouchers;
b) a barcode voucher storage module used to bind the selection numbers and the drawing elements of hidden codes randomly selected, or corresponding numbers of Group 1 and Group 2 plain codes and a barcode code, and store bound information in the database of a game system;
c) a game module used for a player choosing prize-claim elements from among plain codes through the game interface set on the module in accordance with the game rules, or from among the two competing groups of elements from Group 1 plain codes;
d) a read module used to read the barcode information by scanning the barcode result voucher, to activate the corresponding selection numbers and the drawing elements of the hidden codes stored in the database of the game system, or the corresponding numbers of Group 1 and Group 2 plain codes; and
e) a prize-claim module used to select a group of hidden codes and correspond the hidden codes to plain codes in accordance with the selection numbers of the hidden codes, and based on this, the module further compares the prize-claim elements selected by the player and the drawing elements of the hidden codes, to produce a drawing result; or the prize-claim module corresponds Group 1 plain codes with Group 2 plain codes in accordance with the corresponding numbers of Group 1 and Group 2 plain codes, and determines the scores of the two competing groups of elements chosen from Group 1 plain codes in accordance with the score randomly determined and corresponding to each element of Group 2 plain codes, to further produce a drawing result according to the scores of these two competing groups of elements.

15. The indirect drawing device of claim 12, further comprising a result verification module used to release the barcode result voucher completing prize-claim program, and then the player verifies consistency between drawing information sealed up in the barcode result voucher and the drawing information sent out by the game system.

16. An indirect drawing-type system of an entertainment game based on a computer network platform, comprising:
a) a barcode result voucher, in the envelope in which are printed selection numbers and drawing elements of randomly selected hidden codes, or corresponding numbers of Group 1 and Group 2 plain codes;
b) a read module used to read barcode information by scanning the barcode result voucher, to activate corresponding selection numbers and the drawing elements of hidden codes stored in the database of a game system, or corresponding numbers of Group 1 and Group 2 plain codes; and
c) a game host computer comprising a game interface through which the player chooses prize-claim elements from plain codes or two competing groups of elements from Group 1 plain codes in accordance with the game rules; after the game begins, the game host computer chooses a group of hidden codes and corresponds them to plain codes in accordance with the selection numbers of the hidden codes, and based on this, it further compares prize-claim elements selected by the player and the drawing elements of the hidden codes, to produce a drawing result; or it corresponds Group 1 plain codes to Group 2 plain codes in accordance with the corresponding numbers of the Group 1 and Group 2 plain codes, determines the scores of the two competing groups of elements chosen from Group 1 plain codes in accordance with the score randomly determined and in response to each element of Group 2 plain codes, and then produces a drawing result based on the scores of these two competing groups of elements.

17. The indirect drawing-type system of claim 16, further comprising a result verification module used to release the barcode result voucher completing prize-claim program, and then the player verifies consistency between the drawing information sealed up in the barcode result voucher and the drawing information sent out by game system.

18. The indirect drawing-type system of claim 16, wherein
a) set on the game interface are randomly arranged plain codes composed of numbers with pre-concerted quantity and several groups of randomly arranged hidden codes constituted of family names of single Chinese character with the corresponding quantity; besides, the game interface displays corresponding chart between hidden codes and plain codes determined in accordance with the selection numbers of hidden codes; or
b) set on the game interface are Group 1 plain codes consisting of letters with pre-concerted quantity, Group 2 plain codes comprising numbers with the corresponding quantity and randomly selected Poker cards with the same quantity as Group 2 plain codes corresponding to all Group 2 plain codes; in addition, Group 1 plain codes are set in the outer ring of disc, Group 2 plain codes in the outer ring of disc, and Poker cards between the outer ring and the inner ring and related with the latter; the inner ring randomly rotates relative to the outer ring and stop at the relevant position under control of game system in accordance with corresponding numbers of Group 1 and Group 2 plain codes.

19. The indirect drawing-type system of claim 17, wherein
c) set on the game interface are randomly arranged plain codes composed of numbers with pre-concerted quantity and several groups of randomly arranged hidden codes constituted of family names of single Chinese character with the corresponding quantity; besides, the game interface displays corresponding chart between hidden codes and plain codes determined in accordance with the selection numbers of hidden codes; or
d) set on the game interface are Group 1 plain codes consisting of letters with pre-concerted quantity, Group 2 plain codes comprising numbers with the corresponding quantity and randomly selected Poker cards with the same quantity as Group 2 plain codes corresponding to all Group 2 plain codes; in addition, Group 1 plain codes are set in the outer ring of disc, Group 2 plain codes in the outer ring of disc, and Poker cards between the outer ring and the inner ring and related with the latter; the inner ring randomly rotates relative to the outer ring and stop at the relevant position under control of game system in accordance with corresponding numbers of Group 1 and Group 2 plain codes.

20. The indirect drawing-type system of claim 16, further comprising a plurality of barcode result vouchers, the player selects one of them in a game as the result voucher of the game.
